(19) United States
(12) Patent Application Publication
(10) Pub. No.: US 2020/0160404 A1
(43) Pub. Date: May 21, 2020

(54) METHOD FOR ENABLING ADVERTISING OR PROMOTIONAL INFORMATION PRESENTED DURING CONTENT BEING PLAYED TO BE SAVED IN A DIGITAL WALLET FOR LATER ACCESS

(71) Applicant: ACTV8, Inc., Beverly Hills, CA (US)

(72) Inventor: Brian Shuster, Beverly Hills, CA (US)

(21) Appl. No.: 16/673,905

(22) Filed: Nov. 4, 2019

Related U.S. Application Data
(60) Provisional application No. 62/768,581, filed on Nov. 16, 2018.

(51) Int. Cl. G06Q 30/02; H04N 21/81; H04N 21/478

(52) U.S. Cl. CPC G06Q 30/0277; H04N 21/47815; H04N 21/812; G06Q 30/0239

(57) ABSTRACT

A method for enabling advertising or promotional information presented during content being played to be saved for later access. The method includes receiving a video or audio link from an external source for playing a video or audio on a display device. The display device includes a display screen, processor and communications components to enable the display device to communicate via a media network. During the playing, the method further includes receiving an offer from a second external source, pausing the playing and displaying the offer on the display device. While displaying the offer, the method presents an option on the display device to save the offer and which then continues the playing after the offer is saved. The offer is saved to a wallet app running on the display device.

### BACKGROUND OF THE INVENTION

The invention is directed to improvements concerning how offers (static or streaming) are provided to consumers on interactive streaming devices by enabling the delivery of offers during the streaming of audio and video content. The offers can be saved to a digital wallet on the digital device so that the user can continue to have the audio or video content streamed and be able to access the saved offer at a later time by accessing the digital wallet whenever desired.

FIG. 1 represents a mobile device or other display device 11 with advertising 13 presented while an audio or video content 15 is being played. It shows a ‘Learn More’ button 17 which, when selected, links to information 19 from an external website. In this manner, current online ad or streaming ads provide an option for a user to click through to ‘Learn More’ or purchase a product/service from a link embedded in the video content. The current market solution takes a user from the audio or video content 15 being played and typically opens a new tab for the user to then browse and choose how to proceed, typically to obtain more information or to make a purchase. The result is distracting for users as it takes them completely out of the audio or video content that they had been listening to or watching. It also creates an issue for the streaming platform, as the user now leaves the streaming platform to see the content on the advertiser's link.

### SUMMARY OF THE INVENTION

Currently, when a user is watching a video or listening to audio content via a browser or via an app on a mobile device, when an ad plays there is not much action for the user to do other than skip the ad, if such option is available, tap to open a URL provided by the ad, or wait until the ad is over. This invention is directed to a new digital ad concept that allows the user to receive relevant products/offers/coupons/digital currency or anything else of value or possible interest to a user (hereinafter “offer”) based on the ad being served and the user watching the ad and saving the offer directly to a user's digital wallet app, e.g., Apple® Wallet, Google® Pay or other third-party wallet app.

More specifically, the invention allows for delivering advertising information during playback of a video or audio commercial on a mobile device or other display device by displaying user engagement prompts, for example through tapping a button, that prompts an offer currency to be saved into a digital wallet. This allows the user to continue watching the video or listening to the audio content with minimal delay and distraction while maintaining the ability to revisit the offer by accessing the digital wallet at any later time.

As an example, when a user is on a mobile device watching video content via a website or app and when available, an advertising offer is displayed. The user saves the offer to a digital wallet and continues to watch the video content, knowing that the offer can be accessed at any time.

The invention enables video or audio content while being played to trigger an offer and with one click, the user can save the offer to a digital wallet, which, other than minimally, does not distract the user from the video or audio playing, which then continues to play. Unlike the prior art, the user is not taken to the advertiser's web platform and continues to stay within the audio or video streaming environment.

### BRIEF DESCRIPTION OF THE DRAWINGS

FIG. 1 is a diagram showing a mobile device or other display with a prior art ad on top of a video.

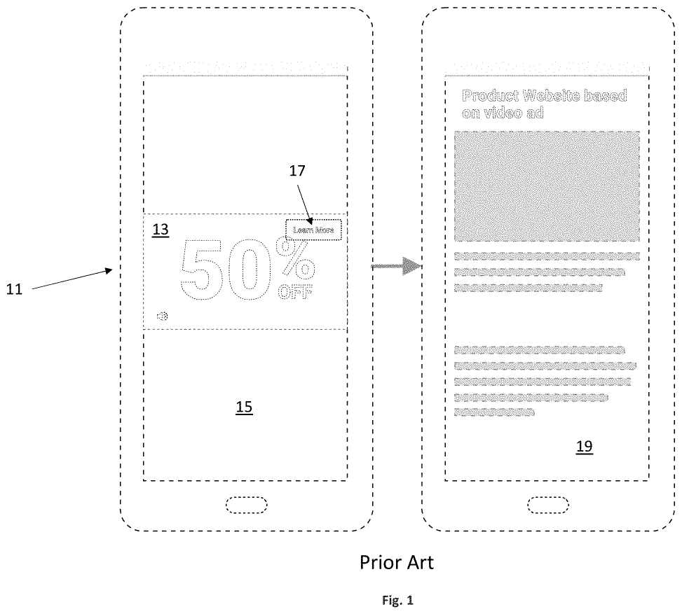

FIG. 2 is a diagram showing a mobile device or other display with a ‘Save & Skip’ button provided by the invention.

FIG. 3 is a diagram showing the workflow related to a ‘Save & Skip’ button provided by the invention.

FIG. 4 is a functional block diagram showing the various elements used by a mobile or other display device, backend server and wallet app to implement the invention.

FIG. 5 is a detailed block diagram showing the process required to access and deliver video content and save an offer for later access.

FIG. 6 is a detailed block diagram showing the Sequence Diagram of API calls to deliver an offer using a media trigger.

FIG. 7 is a detailed block diagram that highlights the requests made by an API client in order to retrieve the necessary metadata to control the interactivity of a media player.

### DETAILED DESCRIPTION OF THE INVENTION

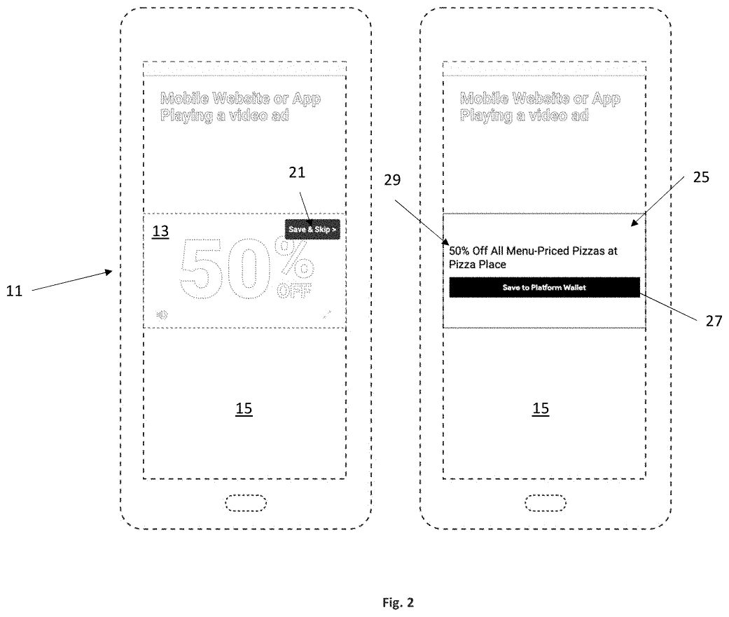

FIG. 2 represents a screen of a mobile device displaying a video being played with the invented save and skip functionality allowing users to save the offer to a digital wallet for later use, skip the rest of the ad and continue viewing the video being played.

As shown in FIG. 2, a video player of any kind running on a mobile or other display device 11 is playing a video 15, which, when paused, presents an ad or offer 13 as in the prior art. The mobile/display device such as a mobile phone or computer tablet includes communications components to enable the device to communicate with other devices or servers over a network such as the Internet or a phone network. Such communications components and communications capabilities are well known in the art, and therefore, will not be further described herein. However, the invention includes a ‘Save & Skip’ button 21. The wording inside the button is dynamic and can be customized as desired (i.e. ‘Save Offer & Skip’). Although not required, when button 21 is displayed, the ad screen area is changed to a neutral background so that the ad content is clear. The ad can be in the nature of an offer related to the video content or can be completely unrelated. Button 21 is an active button which provides the ability to deliver an offer to a digital wallet app. If required by the OEM wallet provider (i.e. Google Pay, Apple Pay), when selected, button 21 causes the display to show an overlay containing further details 25 concerning the ad/offer, possibly with a title 29 related to the ad for easy reference, and a button 27, which causes the ad/offer to be saved to a digital wallet app, typically running on the display device. If not required by the OEM wallet provider, when selected, button 21 can save the offer directly into the digital wallet on behalf of the user. After the ad is saved, the video 15 immediately resumes playing. Button 21 can also enable the video to be resumed without saving the offer. This would be similar to the prior art where a displayed ad can be closed. However, unlike the prior art, if the offer is something that may be of future interest to the user, by saving the offer in the digital wallet, the user can return to the offer at any later time.

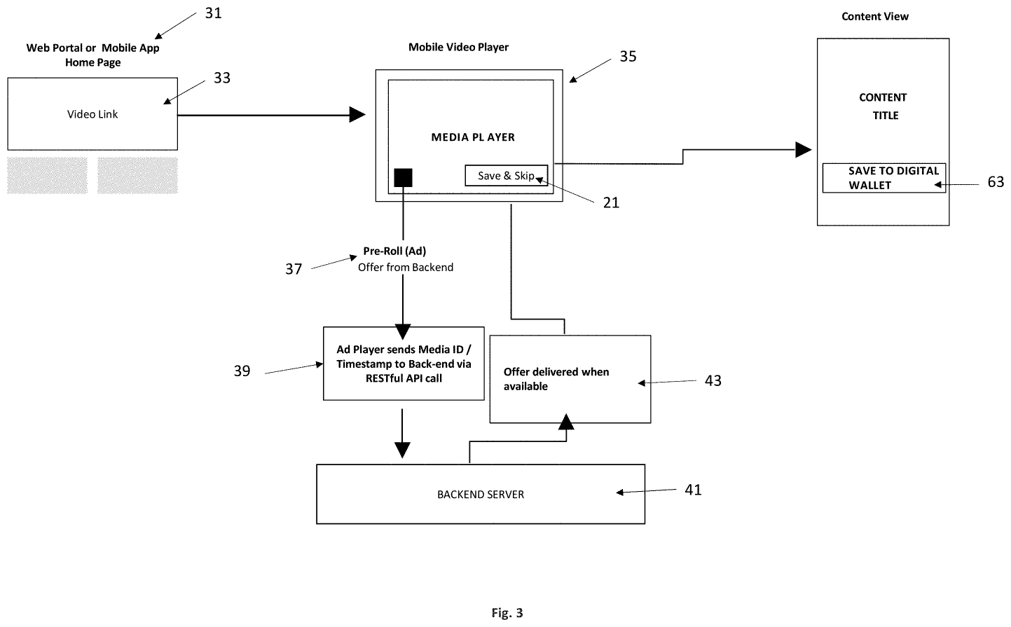

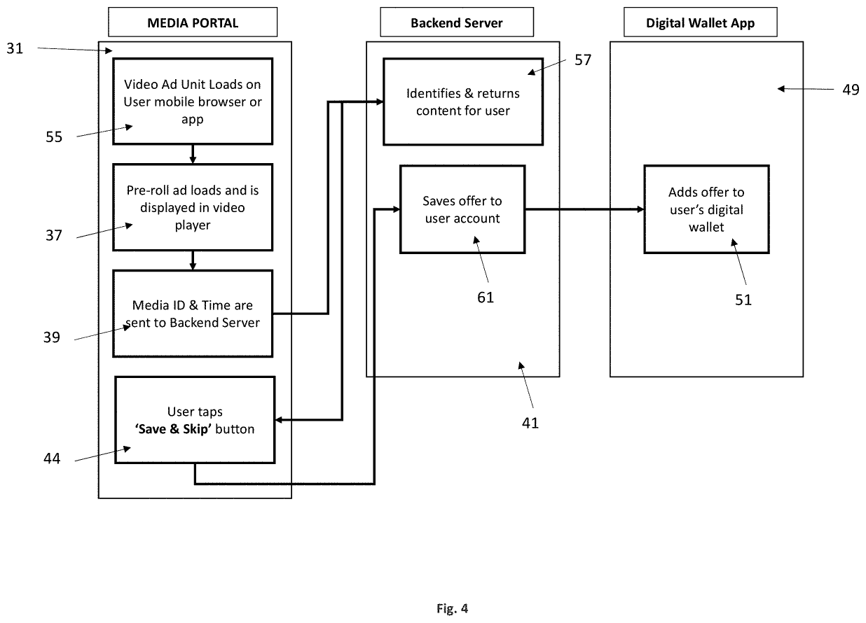

FIG. 3 is a diagram showing the workflow related to a ‘Save & Skip’ button 21 (see FIG. 2) provided by the invention allowing users to save an offer to a digital wallet for later use, skip the ad and continue viewing the video. FIG. 4 is a functional block diagram showing the various elements for allowing users to save an offer to a digital wallet for later user, skip the ad and continue viewing the video. As shown in FIG. 4, the first element is media portal or mobile app 31, the second element is backend server 41.

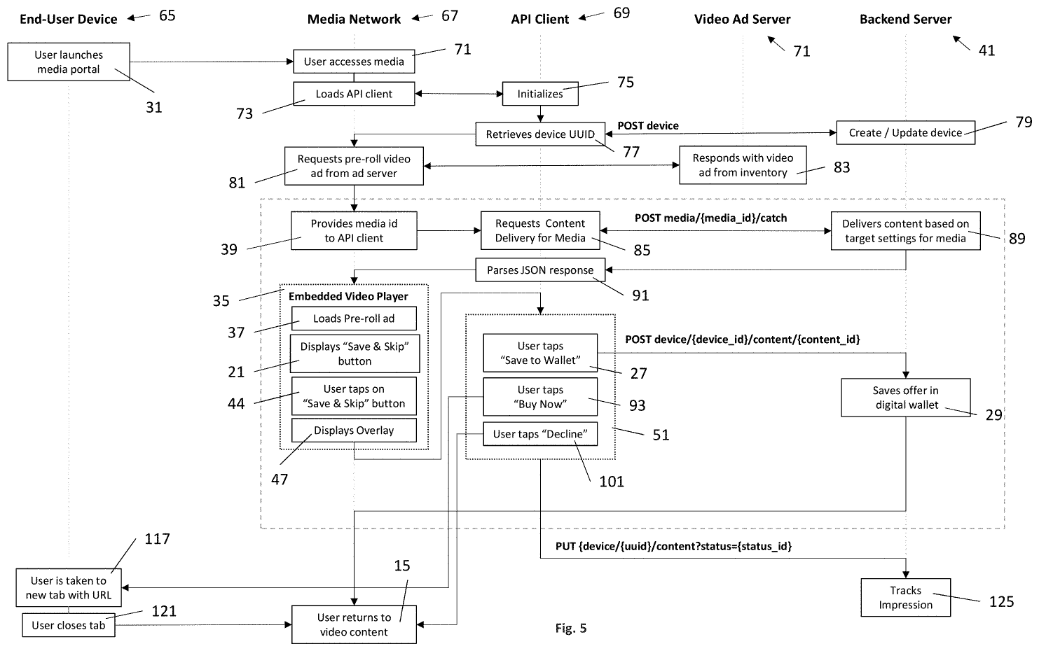

With reference to FIGS. 3 and 4, a web portal or mobile app home page 31 sends a video link 33 to a mobile video player 35 or other device video player. Of course, instead of mobile video player 35, a video player for another device, such as a desktop computer can be used. The video provided by video link 33 is played using media player 35. As the video is playing, a pre-roll (ad) 37, obtained from web portal or mobile app home page 31, or other external video source is also presented on the display via a video ad player 39. Video ad player is another video player running on device 11, or the ad may be handled directly by media video player 35. The video ad player obtains from the ad a video media ID and timestamp representing the location of the ad relative to the video being played. The video ad player then sends the information to a backend server 41 via a RESTful API call which is a client-server request made via an API client to the backend server which includes an API to communicate with the client API. The API client is a system running on device 11 that initiates the request using valid API credentials. The video ad is provided by a video ad server 71 (shown in FIG. 5), is a third party server that delivers video advertisements requested by a publishing/advertising platform. Such third party video ad servers are well-known ad server solutions such as Google® AdWords and AppNexus. The backend server and video server communicate with device 11 over a network such as the Internet or phone network as is well known in the art

Backend server 41 receives the RESTful API call, and using the video media ID/timestamp, locates a corresponding offer from a third party content database which may be stored on backend server 41 which is delivered 43 to video player 35 when available. The ‘Save & Skip’ button 21 is also presented at this time. When button 21 is selected, the display on the display screen of video player 35 changes to show the content and title of the offer along with save to wallet button 27.

When save to wallet button 27 is pressed, a digital wallet app 49 on device 11 is executed to add 51 the offer for later access by the user accessing the digital wallet. Once the offer has been saved to the digital wallet, video player 35 resumes the video which was playing before the offer was presented. In a like manner, with the use of multiple time markers, additional offers may be presented from time to time as the video is being played, which offers may also be saved to the digital wallet.

Media portal/app 31 operates by first loading 55 a video ad unit on a browser or app running on device 11. In this regard, a video ad unit is an audiovisual linear advertisement presented to the end user prior to the streaming of the requested media

Once loaded, the pre-roll ad 37 with an offer is loaded and is displayed by video player 35. The media ID/timestamp obtained from the ad are sent to backend server 41 which operates to identify and return content 57 in the nature of a targeted offer matching the end-user demographics to the mobile device on which the video is being played. As noted above, the display at this time presents a ‘Save & Skip’ button 21 to the user, which, when pressed 44, sends the signal to backend server 41 which then delivers 57 to the user and, if required, displays an overlay with the save to wallet button 27 which, when pressed, saves 61 the offer to the user account and then returns the user to the media portal/app which resumes the video which was being played prior to the offer being presented. Alternatively, if not required by the OEM wallet provider, the offer can be automatically saved 63 into the user's mobile device digital wallet, and then the web portal/app resumes the video which was being played prior to the offer being presented. The user account is a record on the backend server's database that holds information to uniquely identify users of the system.

FIG. 5 is a diagram showing in more detail the process required to setup an offer using the invention and deliver via a media trigger. The elements shown in FIG. 5 are user device 65 which may be a mobile phone or other mobile device 11, or desktop computer, media network 67 which device 65 uses to communicate via API client 69 also installed on end-user device 65 with two external servers, namely video ad server 71, and backend server 41.

The actions taken by these various elements appear in FIG. 5 in a column below the respective elements. The first step is for a user to launch a media portal/app 31 from which the user accesses media 71 via video link 33 (not shown in FIG. 5) at which time a selected video begins to play. API client 69 is then loaded 73, and initialized 75. The API client retrieves the device UUID 77, and contacts backend server 41 to either create or update 79 device 65 on backend server 41, so that subsequent actions by backend server 41 are properly handled by device 65.

After the video has been playing, at a predetermined time, device 65, through the media network 67, requests 81 a pre-roll video ad from video ad server 71 which responds 83 with a video ad from an ad inventory. The video ad which has a media ID and timestamp is provided 39 to API client 69 which in turn requests content delivery 85 which is delivered 89 as a JSON response which is parsed 91 by API client 69. Specifically, the tittle, description, main image URL, thumbnail URL, redemption URL, and redemption barcode are extracted from the server JSON response of the delivered offer, in order to render a visual representation for the end user to interact with.

The result is provided to video player 35 which loads 37 the pre-roll ad, and displays the ‘Save & Skip’ button 21. If required by the OEM wallet provider, when the user presses button 21, an overlay 51 is displayed 47. Overlay 51 includes the previously described save to wallet button 27, but may also include a buy now button 93 and/or decline button 101, any of which the user may press. Pressing the save to wallet button 27 sends a POST device/{device_id}/content/{content+ID} command to backend server 41. The command causes backend server 41 to save 27 the offer in the digital wallet. Alternatively, if not required by the OEM wallet provider, the offer can be directly saved into the user's digital wallet upon the pressing of button 21

API client 69, in addition to providing the save to wallet button 27, as noted above, can also provide a buy now button 93, and a decline button 101. If the buy now button is pressed by the user, the display on end-user device 65 is provided with a URL 117 which displays a screen from which the user may begin a purchase of the item previously offered. The specifics of this operation are well known and therefore, need not be further described. Similarly, if the user presses the decline button 101, then the offer display is closed 121, and the video content 15 begins to play again. Whether button 27, 93 or 101 is pressed, API client 69 issues a PUT{device/{uuid}/content?status={status_id} to the backend server 41 which performs a tracks impression operation 125. The purpose of the tracks impression operation is to collect transactional data on all user and system interactions with an offer

The API client 69 serves as an interface to communicate with the backend server. The API client is embedded in the media network platform 67. Upon initialization, the API client retrieves the device unique identifier (UUID) from the operating system of device 65. Using the device UUID, the API client sends a request to the backend server to create a device entry for the unique device. The media network provides the agent with the unique media id prior to the media streaming. Using the media id, the API client requests the timemarks (the points in the timeline where the “Save ads” buttons should be displayed). The API client uses the media id and timemarks to request the delivery of offers associated with the media. The backend server responds with the associated offers, targeting all the available demographic information for the device and the user.

The API client provides the media player with all the necessary metadata to allow for interactivity during the streaming of the media. The media player initiates the streaming of the media.

When the user taps 44 on the ‘Save & Skip’ button 21, the API client renders the action buttons: “Save to wallet”, “Buy” and “Decline”.

If the user taps on “Save to Wallet”, the API client prompts the user to save or decline the saving of the offer.

If the user taps on “Buy”, the API client opens a new browser window and directs the user to the offer URL.

If the user taps on “Decline”, the API client dismisses the button actions overlay, after which the user continues watching the media content.

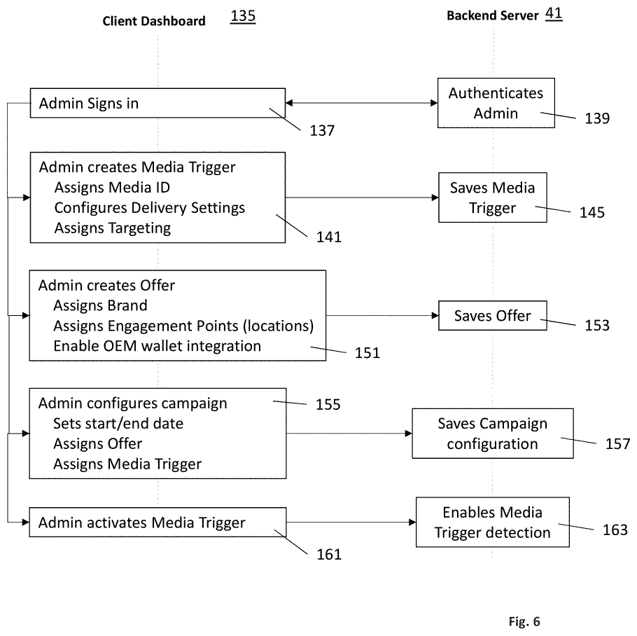

FIG. 6 is a diagram showing the Sequence Diagram of API calls to deliver using the invented deliver an offer using a media trigger. FIG. 6 shows the processing performed by each of client dashboard 135, and backend server 41. Client dashboard 135 is a system component that provides a user interface to allow administrators to manage their advertising campaigns. After an administrator sign-in 137, authenticated 139 by backend server 41, the administrator can proceed to create a media trigger 141 by assigning a media ID, configuring delivery settings such as delivery mode (i.e. sequential, multiple, random), content groups, delivery frequency among other settings, and assigning targeting, which allows for the delivery of specific offers based on user demographics. The created media trigger is saved 145 by backend server 41. The administrator also creates an offer 151 which involves assigning a brand, engagement points (locations) and otherwise enabling wallet integration which involves setting the specific OEM wallet (i.e. Google® Pay, Apple® Pay). The created offer is saved 153 by backend server 41. The administrator also configures the offer campaign 155 by setting the start and end date, assigning the offer to the corresponding media trigger and assigning the media trigger to the campaign. The configured campaign is saved 157 by backend API server 41. Once this is completed, the administrator activates 161 the media trigger so that the backend server 41 enables 163 the media trigger for detection.

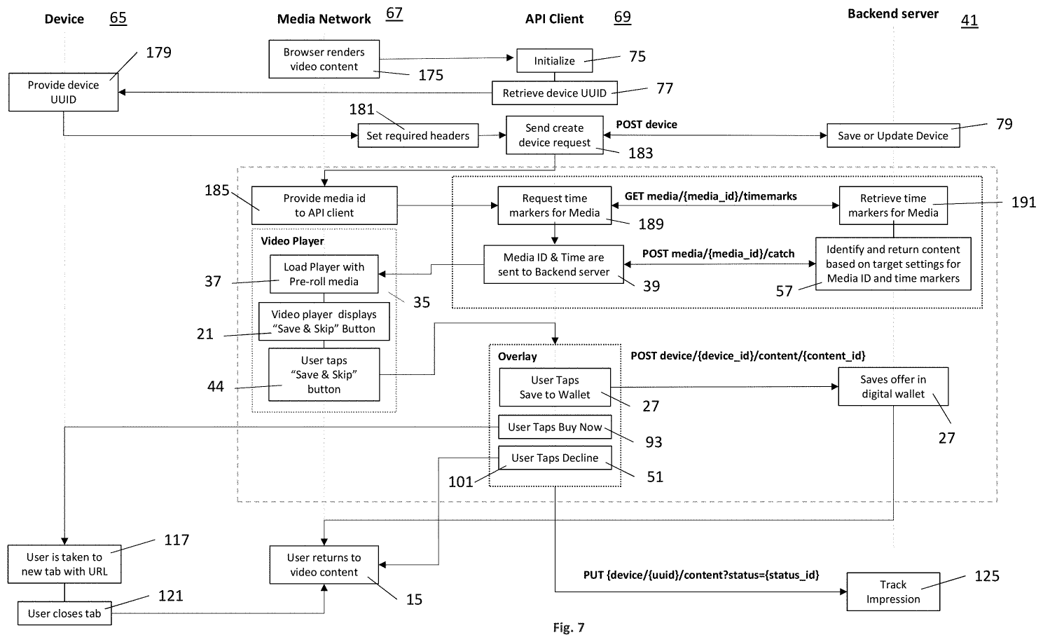

FIG. 7 is a diagram that highlights the requests made by the API client in order to retrieve the necessary metadata to control the interactivity of the media player. FIG. 7 provides additional detail on the processing performed by the various elements shown in FIG. 5. As the browser 175 renders video content on device 65, it initializes API client 69. When device 65 provides 179 its UUID to API client 69, it also sets required headers 181 which include the API KEY and API VERSION that is used as an authentication method for client-server requests. This triggers API client 69 to send a create device request 183 to backend server 41, and requests the media network to provide 185 the media ID which is sent to API client 69 to request 189 time markers for media from backend server 41 by sending a GET media/{media_id}/timemarks command to backend server 41 which retrieves 191 time markers for the media. API client 69 also sends 195 the media ID and time markers to the backend server, and to video player 35 which then loads 37 the player with pre-roll media which, when triggered by the time markers, displays a ‘Save & Skip’ button 21 which when tapped 44 by the user causes API client 69 to display overlays buttons 27, 93 and 101 as described above.

The invention may be implemented in alternative ways. Embodiments of the invention may locate components in different locations that may be together within a single location or scattered across various locations, and they may consolidate multiple components within a single component that performs the same functions as the consolidated components.

An embodiment of the invention may be a machine-readable medium having stored thereon instructions which cause a processor to perform operations as described above. In other embodiments the operations might be performed by specific hardware components that contain hardwired logic. Those operations might alternatively be performed by any combination of programmed computer components and custom hardware components.

A machine-readable medium may include any mechanism for storing or transmitting information in a form readable by any type of processing device.

Although specific examples of how the invention may be implemented are described, the invention is not limited by the specified examples, and is limited only by the scope of the following claims.

1. A method for enabling advertising or promotional information presented during content being played to be saved for later access comprising:
receiving a video or audio link from an external source for playing a video or audio on a display device, said display device including a display screen, processor and communications components to enable said display device to communicate via a media network;
during said playing, receiving an offer from a second external source, pausing said playing and displaying said offer on said display device;
while displaying said offer, presenting an option on said to display device to save said offer, wherein selecting said offer saves said offer to a wallet app running on said display device;
wherein said display device includes an API client, and a video player and said communications components enable said display device to communicates with a backend server and a video ad server over a network;
wherein a pre-roll ad with an offer is loaded and displayed by said video player, said pre-roll ad including a media ID/timestamp which is sent by said video player to said backend server; and
said method further comprises triggering said API client to send a create device request to said backend server, which provides a media ID which is sent to said API client which API client then initiates a request for time markers from said backend server for the content playing on said display device.

2. The method defined by claim 1, wherein after offer is saved, resuming said playing.

3. The method defined by claim 1 wherein said offer is related to said content being played.

4. The method defined by claim 1 wherein said presented option includes an active button which when selected by a user causes an overlay to be displayed on said playback device, said overlay containing further details for said offer and a second active button which when selected by said user, saves said offer to said wallet app.

5. The method defined by claim 1 wherein said presented option includes an active button which when selected by a user directly saves said offer to said wallet app.

6. (canceled)

7. (canceled)

8. The method defined by claim 7 wherein said backend server operates to identify and return content in the nature of an offer to the display device.

9. The method defined by claim 8 wherein said presented option includes an active ‘Save & Skip’ button which when pressed sends a signal to said backend server which then causes the display device to display an overlay with a save to wallet button which, when pressed, saves the offer to one of a user account on the backend server and a digital wallet on the display device, after which the content which was being played prior to the offer being presented is resumed.

10. The method defined by claim 4 wherein said overlay further comprises a buy now button which when pressed presents on the display device information to enable a purchase to be made based on said offer and a decline button which when pressed causes said paused content to resume playing.

11. (canceled)

12. The method defined by claim 1 wherein said API client sends the media ID and time markers to the backend server, and to said video player which then loads the pre-roll ad which, when triggered by the time markers, displays an active ‘Save & Skip’ button which when pressed causes said API client to display an overlay which includes an active ‘Save to Wallet’ button, an active ‘Buy Now’ button and an active ‘Decline’ button.

13. The method defined by claim 12 wherein after one of said Save to Wallet’ button, ‘Buy Now’ button and ‘Decline’ button is pressed, said playing is resumed.
